(19) United States
(12) Patent Application Publication
(10) Pub. No.: US 2024/0204359 A1
(43) Pub. Date: Jun. 20, 2024

(54) BATTERY PACK FLOATING BUS BAR ASSEMBLY

(71) Applicant: Ford Global Technologies, LLC, Dearborn, MI (US)

(72) Inventors: Caleb Wang, Canton, MI (US); Steve Droste, Canton, MI (US); Patrick Daniel Maguire, Ann Arbor, MI (US); John Peter Bilezikjian, Canton, MI (US); Christopher Steven Baldwin, Royal Oak, MI (US); Robert John Link, Northville, MI (US); Kevin A. Montgomery, Royal Oak, MI (US)

(21) Appl. No.: 18/176,585

(22) Filed: Mar. 1, 2023

Related U.S. Application Data
(60) Provisional application No. 63/433,865, filed on Dec. 20, 2022.

(51) Int. Cl. H01M 50/503; H01M 50/209; H01M 50/507; H01M 50/516

(52) U.S. Cl. CPC H01M 50/503; H01M 50/209; H01M 50/507; H01M 50/516

(57) ABSTRACT

A traction battery assembly includes a busbar, a carrier frame having a pocket that receives the busbar, and a cap secured to the carrier frame to contain the busbar within the pocket. A busbar retention method includes positioning at least one busbar with a pocket of a carrier frame and resting the busbar on at least one ledge and securing a cap to the carrier frame to hold the at least one busbar within the pocket.

### CROSS-REFERENCE TO RELATED APPLICATIONS

This application claims priority to U.S. Provisional Application No. 63/433,865, which was filed on 20 Dec. 2022 and is incorporated herein by reference in its entirety.

### TECHNICAL FIELD

This disclosure relates generally to a module that holds busbars used within a traction battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a traction battery assembly, including: a busbar; a carrier frame having a pocket that receives the busbar; and a cap secured to the carrier frame to contain the busbar within the pocket.

In some aspects, the techniques described herein relate to an assembly, further including at least one ledge of the carrier frame, the ledge extending into the pocket to support the busbar.

In some aspects, the techniques described herein relate to an assembly, wherein busbar is sandwiched between the at least one ledge and the cap.

In some aspects, the techniques described herein relate to an assembly, wherein the busbar is configured to move relative to the ledge and the cap when the busbar is sandwiched between the at least one ledge and the cap that is secured to the carrier frame.

In some aspects, the techniques described herein relate to an assembly, wherein the cap is secured to the carrier frame with at least one heat stake

In some aspects, the techniques described herein relate to an assembly, wherein the busbar is configured to float within the pocket.

In some aspects, the techniques described herein relate to an assembly, wherein the pocket is a first pocket and the busbar is a first busbar, and further including a second busbar held within a second pocket, the cap secured to the carrier frame to contain the first busbar within the first pocket and the second busbar within the second pocket.

In some aspects, the techniques described herein relate to an assembly, wherein the pocket opens to a first side of the carrier frame and to an opposite second side of the carrier frame, the first side configured to face a plurality of battery cells when the carrier frame is installed within a traction battery pack, the second side configured to face away from the plurality of battery cells.

In some aspects, the techniques described herein relate to an assembly, wherein the carrier frame is adhesively secured to a plurality of battery cells.

In some aspects, the techniques described herein relate to an assembly, wherein the busbars are configured to contact at least one terminal of the plurality of battery cells, the at least terminal extending into the pocket.

In some aspects, the techniques described herein relate to an assembly, wherein the at least one terminal is welded to the busbar.

In some aspects, the techniques described herein relate to an assembly, further including a plurality of battery cells and a piece of an enclosure of a battery pack, wherein the carrier frame, cap, and busbar are joined directly to the piece of the enclosure and are sandwiched between the piece of the enclosure and the plurality of battery cells.

In some aspects, the techniques described herein relate to an assembly, wherein the piece of the enclosure is an enclosure cover.

In some aspects, the techniques described herein relate to an assembly, wherein the carrier frame includes at least one battery cell venting channel.

In some aspects, the techniques described herein relate to an assembly, including a shielding layer covering portions of the busbar exposed through the pocket.

In some aspects, the techniques described herein relate to a busbar retention method, including: positioning at least one busbar with a pocket of a carrier frame and resting the busbar on at least one ledge; and securing a cap to the carrier frame to hold the at least one busbar within the pocket.

In some aspects, the techniques described herein relate to a busbar retention method, further including contacting the at least one busbar with at least one terminal of a battery cell, the contacting moving the at least one busbar away from the at least one ledge.

In some aspects, the techniques described herein relate to a busbar retention method, securing the carrier frame directly to a piece of an enclosure for a traction battery pack.

In some aspects, the techniques described herein relate to a busbar retention method, wherein the at least one busbar is detached from both the at least one ledge and the cap.

In some aspects, the techniques described herein relate to a busbar retention method, wherein the pocket opens to a first side of the carrier frame and to an opposite, second side of carrier frame. The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows a side view of an electrified vehicle having a traction battery pack.

FIG. 2 shows a perspective and partially expanded view of the traction battery pack of FIG. 1 showing a busbar module, an enclosure, and a cell matrix.

FIG. 3 illustrates a portion of the busbar module of FIG. 2 when loading busbars into pockets of a carrier frame.

FIG. 4 shows a close-up perspective view of a ledge within one of the pockets of FIG. 3.

FIG. 5 shows the portion of the busbar module of FIG. 3 when loading a cap to the carrier frame.

FIG. 6 show the portion of the busbar module of FIG. 4 after the busbar module is assembled and placed adjacent the cell matrix.

FIG. 7 shows a section view taken at line 7-7 in FIG. 6 when the busbar module is placed adjacent the cell matrix.

FIG. 8 shows a section view taken at line 8-8 in FIG. 6 when the busbars of the busbar module are welded to terminals of battery cells within the cell matrix.

### DETAILED DESCRIPTION

Traction battery packs often include busbars connected directly to battery cell terminals.

This disclosure describes housing busbars within a busbar module. The busbars can float within the busbar module as they are connected directly to battery cell terminals. The ability to float can help to accommodate build variations, part variations, etc., when connecting the busbars directly to battery cell terminals. The busbar module can also provide load paths that do not extend through the busbars to facilitate a connection of the busbar module to an enclosure of the traction battery pack.

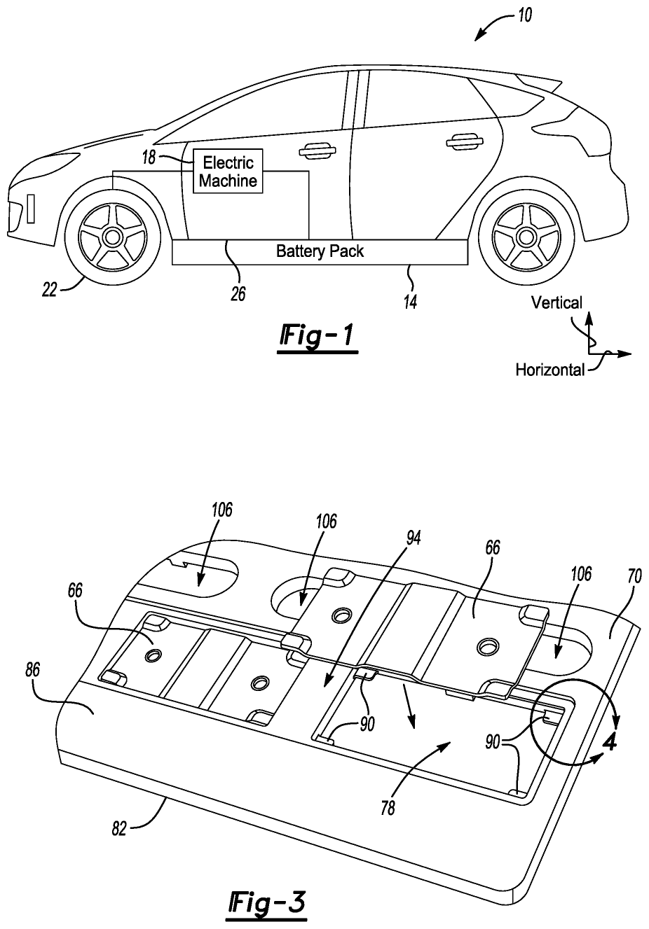

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

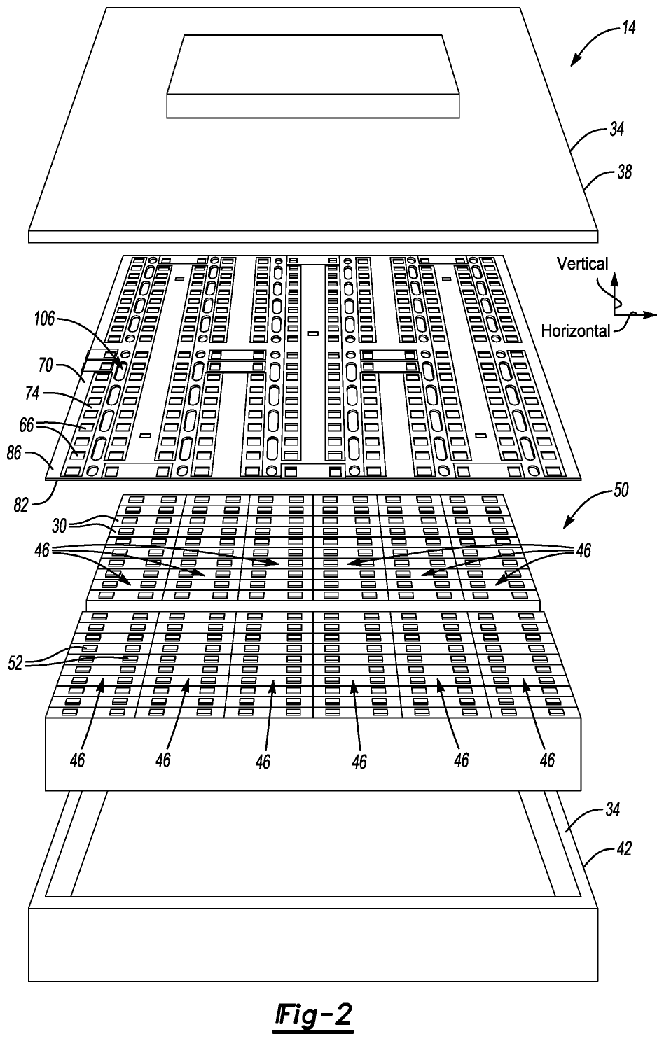

With reference now to FIG. 2, the traction battery pack 14 includes a plurality of battery cells 30 held within an enclosure assembly 34. In the exemplary embodiment, the enclosure assembly 34 comprises various enclosure structures. In particular, the example enclosure assembly 34 includes an enclosure cover 38 and an enclosure tray 42. The enclosure cover 38 and enclosure tray 42 are secured together to house the plurality of battery cells 30. The enclosure cover 38 and the enclosure tray 42 are different types of enclosure pieces. The enclosure cover 38 and enclosure tray 42 enclose battery cells when the traction battery pack 14 is assembled.

The plurality of battery cells (or simply, “cells”) 30 are for supplying electrical power to various components of the electrified vehicle 10. The example battery cells 30 are grouped within one of a plurality of cell stacks 46, which are then positioned side-by-side to provide a cell matrix 50. In this example, each cell stack 46 includes ten individual battery cells 30, and the cell matrix 50 includes twelve cell stacks 46.

The battery cells 30 each include terminals 52. In this example, the cell matrix 50 is arranged such that the terminals 52 are disposed along a vertically upward side of the cell matrix 50. Vertical, for purposes of this disclosure, is with reference to ground and a general orientation of the vehicle 10 during operation.

Although a specific number of battery cells 30 and cell stacks 46 are illustrated in the various embodiments of this disclosure, the traction battery pack 14 could include any number of cells 30 and cell stacks 46. In other words, this disclosure is not limited to the specific cell matrix 50 shown in FIG. 2.

Also housed within the enclosure assembly 34 is a busbar module 60, which, when assembled, is adjacent a side of the cell matrix 50 having the terminals 52. The vertically upward facing side of the cell matrix 50 includes the terminals 52 in this example.

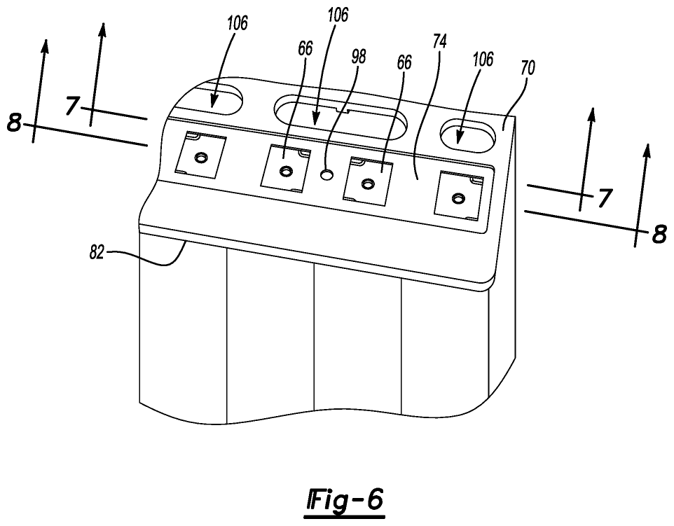

With reference now to FIGS. 3-7 and continuing reference to FIG. 2, the busbar module 60 includes a plurality of busbars 66, a carrier frame 70, and a plurality of caps 74. As can be appreciated, the busbars 66 are a conductive metal or metal alloy. The carrier frame 70 and caps 74 can be a polymer-based materials.

The busbar module 60 can be assembled to hold the plurality of busbars 66 and then mounted adjacent the battery cells 30. In this example, the busbar module 60 is disposed vertically above the plurality of battery cells 30. The plurality of busbars 66 electrically connect together, among other things the battery cells 30 and the cell stacks 46.

The busbars 66 are received within pockets 78 provided by the carrier frame 70. In this example, each pocket 78 receives one busbar 66. In other examples, the pockets 78 each receive more than one busbar 66.

The example pockets 78 extend completely through the carrier frame 70. That is, the pockets 78 each extend from openings in a first side 82 of the carrier frame 70 to respective openings in an opposite, second side 86 of the carrier frame 70. The first side 82 faces the cell matrix 50 in this example. The second side 86 faces away from the cell matrix 50. The second side 86 faces vertically upward in this example.

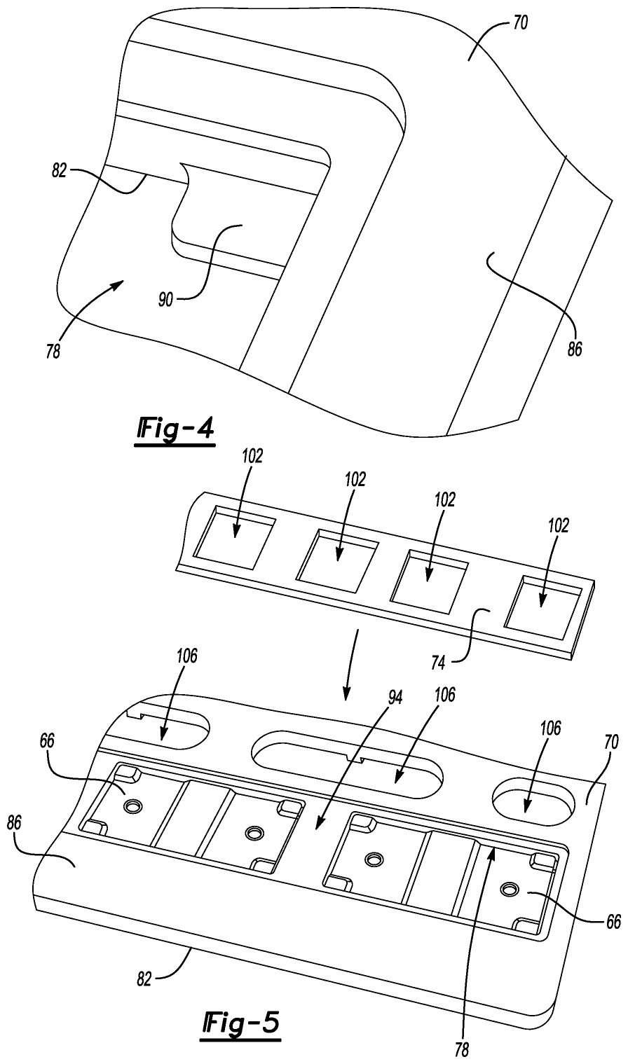

Within the pockets 78, the busbars 66 can rest on a plurality of ledges 90 (FIG. 4). The busbars 66 are initially supported by the ledges 90, which block the busbar 66 from dropping out of the pocket 78 through the opening in the first side 82.

The cap 74 is secured to the carrier frame 70 to contain the busbar 66 within the pocket 78 by blocking the busbar 66 from moving through the opening in the second side 86. Once the cap 74 is secured to the carrier frame 70, the busbar 66 is captured or sandwiched between the ledges 90 and the cap 74. The busbar 66 is configured to float or move relative to the ledges 90 and the cap 74 when the busbar 66 is sandwiched between the ledges 90 and the cap 74.

In this example, the carrier frame 70 includes bridge portions 94 that extend between the pockets 78. Heat stakes 98 can secure the cap 74 to the bridge portions 94 to secure the cap 74 to the carrier frame 70. In another example, the cap 74 could be adhesively secured, snap-fit, or secured to the carrier frame 70 with mechanical fasteners. In other examples, the cap 74 can be secured to the carrier frame 70 with strips of adhesive, double sided tape, or ultrasound welds. In this example, the cap 74 extends over more than one pocket 78 to contain more than one busbar 66 with respective pockets 78. The same cap 74 is thus used to contain more than one busbar 66 in more than one respective pocket 78.

With the busbars 66 contained within respective pockets 78, the busbar module 60 can be mounted adjacent the battery matrix 50. In this example, the busbar module 60 is adhesively secured to the battery matrix 50.

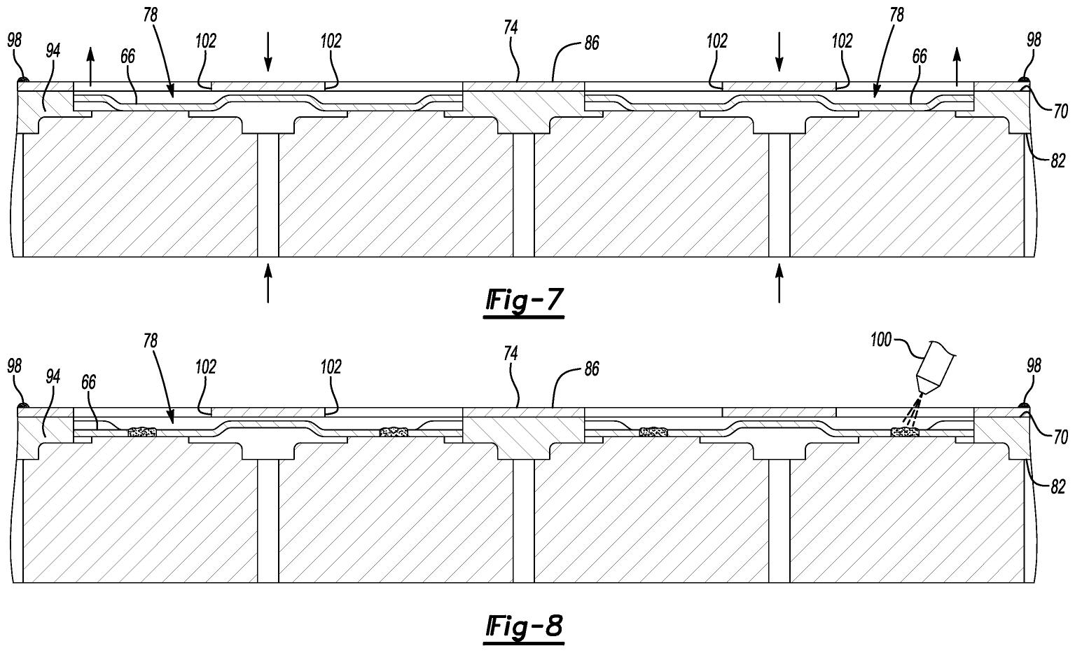

FIG. 7 shows a section view of a portion of the busbar module 60 as the busbar module 60 is mounted to the cell matrix 50. During loading, at least a portion of the terminals 52 extends into the pockets 78 to contact a respective one of the busbars 66. The busbars 66 are configured to contact the terminals 52 when the busbar module 60 is mounted.

Build variations, part variations, etc. can lead to variations in how much of a given terminal 52 extends into the associated pocket 78. The busbars 66, due to their ability to float within the pockets 78, move away from the ledges 90 to accommodate the terminal 52 moving into the pocket 78. The amount that the busbars 66 are moved away from the ledges 90 depends on how far the respective terminal 52 extends into the associated pocket 78. In this example, terminals 52 that extend, say, one millimeter further into the respective pocket 78 than other terminals 52 lift the busbars 66 within those pockets 78 one millimeter further than the busbars 66 in other pockets 78.

After mounting the busbar module 60, the busbars 66 can be welded or otherwise attached to the respective terminals 52 as shown in FIG. 8. When the busbar 66 is spaced from the ledges 90, a welder 100 can access the busbars 66 for welding through access openings 102 in the caps 74. The placement of the busbar module 60 and then welding of the terminals 52 to the respective busbars 66 during assembly can be automated. After attaching the busbars 66 to the respective terminals 52, areas of the busbars 66 exposed through the access openings 103 can be covered with a shielding layer that can be dielectric tape, foam, mylar. The shielding layer may cover only the exposed portions of the busbars 66 or may cover all portions of the cap 74. The shielding layer can be recessed from the uppermost surface of the carrier frame 70 so that loads applied to the carrier frame 70 are not routed through the shielding layer.

After attaching the busbars 66 to the respective terminals 52, the cell matrix 50 and busbar module 60 can be enclosed within the enclosure assembly 34. In this example, an enclosure piece, here the enclosure cover 38, is joined directly to the carrier frame 70 of the busbar module 60, the caps 74, or both. As the busbars 66 are not fixed directly to the carrier frame 70 or the caps 74, a downward directed load applied to the enclosure cover 38 would result in a load path that extends through the enclosure cover 38 and the busbar module 60 without passing through the busbars 66 or the connection of the busbars 66 to the terminals 52. In the past, busbars 66 that were directly secured to a busbar carrier structure may have been detached from any enclosure piece so the busbars are not loaded.

In addition to the pockets 78, the busbar module 60 includes a plurality of venting channels 106. Should one or more of the battery cells 30 of the cell matrix 50 vent during a thermal event, the escaping gas can move through one or more of the venting channels 106 and then be routed out of the battery pack 14.

The busbar module 60 can also incorporate, as needed, various sense lines, sense leads, and thermistors, which may be relied on to monitor voltage, temperature, etc. in various areas of the battery pack 14. In some examples, thermistors (along with leads for the thermistors) can be attached to an underside of carrier frame 70, such as an underside of the bridge portions 94 that face the battery cells 30. The thermistors can be exposed through an opening in the bridge portions 94. After the busbar module 60 is mounted, the thermistor can be accessed through that opening to attach the thermistor to the cell matrix 50.

Features of the disclosed examples and include an integrated BBM design that can reduce part quantity, and facilitate greater battery cell density within the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery assembly, comprising:
a busbar;
a carrier frame having a pocket that receives the busbar; and
a cap secured to the carrier frame to contain the busbar within the pocket.

2. The assembly of claim 1, further comprising at least one ledge of the carrier frame, the ledge extending into the pocket to support the busbar.

3. The assembly of claim 2, wherein busbar is sandwiched between the at least one ledge and the cap.

4. The assembly of claim 3, wherein the busbar is configured to move relative to the ledge and the cap when the busbar is sandwiched between the at least one ledge and the cap that is secured to the carrier frame.

5. The assembly of claim 1, wherein the cap is secured to the carrier frame with at least one heat stake.

6. The assembly of claim 1, wherein the busbar is configured to float within the pocket.

7. The assembly of claim 1, wherein the pocket is a first pocket and the busbar is a first busbar, and further comprising a second busbar held within a second pocket, the cap secured to the carrier frame to contain the first busbar within the first pocket and the second busbar within the second pocket.

8. The assembly of claim 1, wherein the pocket opens to a first side of the carrier frame and to an opposite second side of the carrier frame, the first side configured to face a plurality of battery cells when the carrier frame is installed within a traction battery pack, the second side configured to face away from the plurality of battery cells.

9. The assembly of claim 1, wherein the carrier frame is adhesively secured to a plurality of battery cells.

10. The assembly of claim 9, wherein the busbars are configured to contact at least one terminal of the plurality of battery cells, the at least terminal extending into the pocket.

11. The assembly of claim 10, wherein the at least one terminal is welded to the busbar.

12. The assembly of claim 1, further comprising a plurality of battery cells and a piece of an enclosure of a battery pack, wherein the carrier frame, cap, and busbar are joined directly to the piece of the enclosure and are sandwiched between the piece of the enclosure and the plurality of battery cells.

13. The assembly of claim 12, wherein the piece of the enclosure is an enclosure cover.

14. The assembly of claim 1, wherein the carrier frame includes at least one battery cell venting channel.

15. The assembly of claim 1, further comprising a shielding layer covering portions of the busbar exposed through the pocket.

16. A busbar retention method, comprising:
positioning at least one busbar with a pocket of a carrier frame and resting the busbar on at least one ledge; and
securing a cap to the carrier frame to hold the at least one busbar within the pocket.

17. The busbar retention method of claim 16, further comprising contacting the at least one busbar with at least one terminal of a battery cell, the contacting moving the at least one busbar away from the at least one ledge.

18. The busbar retention method of claim 16, securing the carrier frame directly to a piece of an enclosure for a traction battery pack.

19. The busbar retention method of claim 16, wherein the at least one busbar is detached from both the at least one ledge and the cap.

20. The busbar retention method of claim 16, wherein the pocket opens to a first side of the carrier frame and to an opposite, second side of carrier frame.
